(19) United States
(12) Patent Application Publication
(10) Pub. No.: US 2011/0250389 A1
(43) Pub. Date: Oct. 13, 2011

(54) PRE-RIP

(76) Inventors: Torkild Hofman, Beder (DK); Paul Bjerring, Horning (DK)

(21) Appl. No.: 13/122,450

(22) PCT Filed: Oct. 2, 2009
(86) PCT No.: PCT/DK09/50259

§ 371 Date: Jun. 17, 2011

(30) Foreign Application Priority Data
Oct. 3, 2008 (DK) PA 2008 01389

(51) Int. Cl. B32B 3/10; B65B 61/02

(52) U.S. Cl. 428/136; 83/13

(57) ABSTRACT

Sheet packaging material, of the type used for packaging objects on automatic packaging machines where the material is supplied in very long lengths on reels, where said material may be a single or multi layer material, where means are provided for determining where cut-off lines shall be placed, where cut-off lines indicate sections where the material will be cut when separating the packages from each other after the material has been formed into a package, and where one or more substantially parallel longitudinal slits are provided across said cut-off lines.

### FIELD OF THE INVENTION

The present invention relates to a sheet packaging material of the type used for packaging objects on automatic packaging machines as well as a method for manufacturing such a sheet packaging material.

### BACKGROUND OF THE INVENTION

In the art a vast amount of different packaging materials are available for packaging objects such as candy, potato crisps, nuts, bolts, food stuffs and just about anything. Sheet materials are very thin films and are often made up of one or more layers. Typically the layers will have different characteristics and properties providing the finished packaging material with the desired characteristics such that in some instances they will shield the products inside from UV-radiation, be liquid-proof, avoid vaporization, be permeable for liquid etc. etc. Common for all these types of material is the fact that they are manufactured as packaging materials in very long lanes and wound onto reels before being introduced into automatic packaging machines.

Typically, information relating to the product to be packaged will also be pre-printed on the packaging material.

In the packaging industry there are generally two types of packaging machines, the so-called form fill and seal (FFS), where the process of forming, filling and sealing a bag is done as an in-line operation, and machines forming and sealing a bag with one side open for filling and sealing as an off-line operation.

With respect to the present invention the inventive principle is applicable to any types of film used in the packaging industry of this type and will assist in providing an easy to open feature to the items which are manufactured with the inventive sheet packaging material according to the invention. The invention thus provides a physical characteristic to the sheet packaging material regardless of the structure, composition etc. of the sheet packaging material as such, and regardless of how the sheet packaging material is treated in the process of forming each single package.

In the art using the types of machines mentioned above the packaging material will typically, by means of indication marks pre-printed on the packaging material, be provided with very narrow cut-off zones transverse to the longitudinal direction of the material in which the finished package will be separated from the next package. This zone or line across the packaging material will be referred to as the cut-off line. During the formation of the package in the packaging machine the sheet material will be formed into a tube. Adjacent the cut-off lines the sheet materials will have been shaped into tubes where the longitudinal side edges of the material will have been connected either by welding of gluing or any other suitable means in order to create a tube. One end of the tube will thereafter be sealed crosswise also by providing a weld, adhesive connection or the like such that an open-ended bag is provided. This bag is thereafter filled with the objects which are to be packaged and the following cut-off line is provided with a seal just before the cut-off line whereby the finished package is created such that the material inside the package is limited by cross seals in either end of the package and a longitudinal seal which created the tube. Thereafter cutting means are provided in order to cut along the cut-off line whereby the package is separated and ready for shipment.

In some instances the material will not be provided with indication marks, as mentioned above. In order to determine the correct position of the cut-off lines, the machines are often provided with means for detecting how much material has passed a certain point. This may for example be achieved by simple tachymeter wheels or the like.

The sheet packaging material is usually manufactured on large reels where the lateral width of the reel may be up to 1.6 metres or more whereby it is possible to accommodate a number of lanes of sheet packaging material corresponding to a plurality of packages laterally on such a reel.

A general problem in the art regardless of the material which is being used is the fact that when desiring to open a package manufactured according to a process as described above the user will usually tear at the welds or cross-seals in order to open the package. In this process it is very likely that an uneven opening, tearing the entire package will be the result whereby the package as such becomes useless. In particular when the packaging apparatus creates a longitudinal fin, users will tend to pull at the fin in order to break the cross seal thereby gaining access to the objects stored in the interior of the package.

In the art various solutions has been proposed, in order to provide packages incorporating means for assisting in opening the finished package.

One example is WO 2006/062787, wherein pre-formed cuts are made in the packaging material prior to the material being entered in the packaging machine. The cuts are made at appropriate relative distances along the side edges of the packaging material, such that as the packages are formed, the cuts will be placed in a welding zone. The cut will assist in initiating tearing open the package. The cuts in the side edges does however have drawbacks due to the fact that the cuts will also initiate cross-wise tearing when the packaging material is being pulled through the packaging machines, such that either the pulling forces in the packaging materials shall be closely controlled and reduced, the manufacturing speed reduced or stronger (and typically more expensive) packaging materials shall be used.

From EP 0579030 is a package known with an easy open feature. The easy open feature comprises a double layered structure. In a first layer a rather long slit is cut and in the second layer is provided a number of smaller cuts arranged (in use) at an angle to the cut in the first layer. During formation of the package the two layers are superposed. In order to open the package the construction relies on the contents being rigid or semi-rigid, in that the slit in the first layer shall be placed adjacent an edge of the contents, such that by bending the package around the edge of the contents, the package will tear. This construction is is rather complicated and relies on certain properties of the contents, which therefore makes it unsuitable for a vast number of applications.

### OBJECT OF THE INVENTION

It is therefore an object of the present invention to provide a sheet packaging material where prior to introducing the sheet packaging material into the packaging machine an easy to open feature is provided, which alleviates the drawbacks with prior art suggestions.

### DESCRIPTION OF THE INVENTION

The invention does this by providing a sheet packaging material of the type used for packaging objects on automatic packaging machines where the material is supplied in very long lengths on reels, where said material may be a single or multi layer material, and where means are provided for determining where cut-off lines shall be placed, where cut-off lines indicate sections where the material will be cut when separating the packages from each other after the material has been formed into a package, and where one or more substantially parallel longitudinal slit(s) parallel with the side of the packaging material are provided extending at least a certain distance from each of every or every other of said cut-off lines.

The slits will on the finished package, after it has been filled as described above, be present in the cross-seal, orimmediately outside the cross seal for packages where the cross seal is not adjacent the edge of the package or partly in the cross seal and partly outside the cross seal. This is irrespective of whether it is a weld or an adhesive cross seal. By positioning the one or more slits on the sheet relative to the side edge such that the slit will be present immediately adjacent the side fin, the package will have achieved the same inventive features as is already described in the same applicant's prior patent application filed in Denmark with application no. PA 2008 00247.

The indication marks are already typically provided on these types of packages in order for the automatic packaging machines to recognize the exact position of the packaging material relative to the cut-off line such that the print comprising the design, trademark, list of contents etc., will be correctly placed on each finished package. The indication marks, also sometimes called photo cell marks, are typically arranged along a side-edge of the finished package and a photo cell in the packaging machine will be able to detect one or more indication marks simultaneously in order to calculate the correct position of the cut-off line.

Where indication marks are not present on the material, the appropriate position will be determined as described above, for example by means of a tachymeter or other means of measuring.

The position of the cut-off line is therefore very well established, and the same indication marks may therefore be used when creating the slits in the sheet packaging material such that only very small tolerances are needed in order to position the slits correctly on the sheet packaging material. In embodiments where a plurality, e.g. 3, 4 or 5 parallel slits are provided, the likelihood of placing the slits correctly relative to the longitudinal fin is increased such that the easy to open feature will be more pronounced. It is, however, not important that the slit is provided immediately adjacent the fin in that the slit will function as an indicator for starting a tear which tear will propagate towards the side fin which will typically be welded such that a very well-defined opening will be made possible along the side fin due to initiation by the slit.

As only one slit is needed in each package it is only necessary to provide a slit extending in one direction from the cutting line. In embodiments where the slit is placed across the cut-off lines it is only necessary to provide slits on every other cut-off line, as this will result in one slit in each package.

In a further advantageous embodiment the longitudinal direction of the material on either side of the cut-off lines a tolerance area of +/−1-3 mm in the longitudinal direction is provided, adjacent which on both sides of the tolerance area a sealing zone of 7 to 15 mm is provided, and where the slits are present in the sealing zone.

In order to take into account the tolerances for these types of machines which usually operate at very high speeds it is necessary to provide a tolerance area which effectively may be up to 6 mm. With most of the modern machines this is sufficient in that the indication marks pre-printed on the sheet typically will be used in order to adjust the speed with which the sheet material is transported through the machine such that cut-off lines and the eventually cutting off of the separate packages will be performed at the correct positions.

In addition to the tolerance area provided for the cut-off lines it is also foreseen that a sealing zone, i.e. zone where the welding of the sheet material will be placed. Typically, the welding will have an extent of 7-10 mm, and by providing a further tolerance in the sealing zone it is possible to ensure that both the cut-off lines will be placed in the appropriate area relative to the seal and that sufficient space is provided for the seal and furthermore that it is ensured that the one or more substantially parallel longitudinal slits are provided across the cut-off lines and into the sealing zone.

In a still further advantageous embodiment the slits are arranged adjacent one longitudinal side of the material, where the outermost slit is spaced 5 to 25 mm from said side.

As typically the two longitudinal sides of the material sheet will be connected when forming the tube which will be the resulting package after being sealed in both ends by placing the slits adjacent one side the slits are already placed in a position where they are close to the longitudinal fin which will be provided when assembling the two sides of the material sheet.

In a still further advantageous embodiment of the invention the material comprises a plurality of layers, where each layer has different characteristics, and where the slit at least penetrates one layer.

In the art it is well-known to use multi-layer sheet where each layer will provide the finished packaging material with certain characteristics relating to rip-direction, vapour permeation, UV protection etc. etc. As some of these layers may be very thin and without providing any substantial strength to the packaging material, it may in some embodiments solely be sufficient to provide the slits in one material layer, for example the layer defining the rip-direction or the main carrier layer in the plurality of layers making up the sheet packaging material.

In a still further advantageous embodiment a plurality of material length are laterally arranged on the same reel. Typically, a package used for candy or the like will have a material width of for example 30 cm resulting in a package having a width of substantially 14 cm such that by providing a plurality of material lengths, that is to say lengths with a width of 30 cm on one reel, it is possible to manufacture the sheet packaging material in a rational manner by having a plurality of sheet material lengths arranged laterally on the same reel such that the reel's width will comprise 5, 6 or 7 or more lengths laterally on the same reel.

The invention is also directed at a method for manufacturing a sheet packaging material suitable to be used in an automatic packaging machine, where means are provided for determining the position of cut-off lines transverse to the longitudinal direction of the material, which cut-off lines determines the longitudinal length of each package to be, where the material is unwound and passed by a cutting means, where said cutting means cuts one or more slits in a position relative to the cut-off lines and at a predetermined distance from the side edge of the material, such that the slits traverses every or every other cut-off line between adjacent packages to be, before the material is being wound up on a reel again.

And further to an alternative method for manufacturing a sheet packaging material suitable to be used in an automatic packaging machine, where means are provided for determining the position of cut-off lines transverse to the longitudinal direction of the material, which cut-off lines determines the longitudinal length of each package to be, where the material is unwound and passed by a cutting means, where said cutting means cuts one or more slits in a position relative to the cut-off lines and at a predetermined distance from the side edge of the material, such that the slits traverses every or every other cut-off line between adjacent packages to be, where after the material is introduced into the packaging machine.

Further advantageous embodiments of the inventive method according to the invention are set out in the further dependent claims.

### DESCRIPTION OF THE DRAWING

Detailed embodiments of the inventive principle will be described with reference to the accompanying drawing in which

FIG. 1 illustrates a material sheet according to the invention;

FIG. 2 illustrates a detailed view at the cut-off line;

FIGS. 3 and 4 illustrates embodiments where a plurality of sheet lengths are arranged side by side laterally;

FIG. 5a-d illustrates various configurations of the sheet from raw sheet towards finished package;

FIG. 6 illustrates a schematic perspective view of a package.

### DETAILED DESCRIPTION OF THE INVENTION

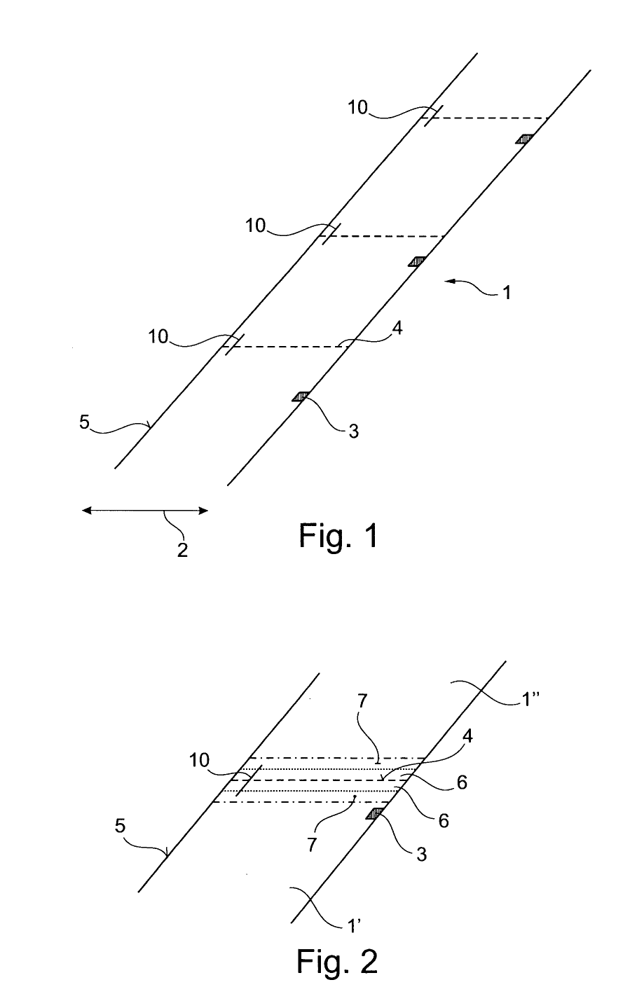

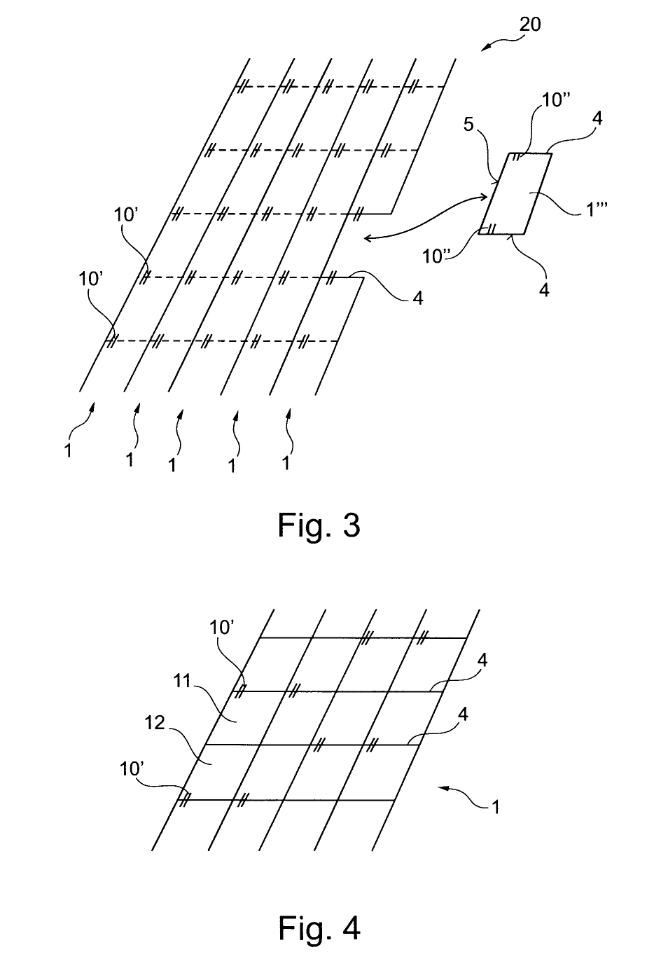

In FIG. 1 is illustrated a length of packaging material 1 according to the present invention. The packaging sheet material 1 may be a multi-layered construction which has a thickness measured in fractions of mm. The length of the material sheet and the width of the sheet may be chosen according to the desired package size, but during manufacturing of the packaging material the sheet will typically be in very long lengths measured in hundreds of meters which are wound onto large reels before being introduced into the packaging machines. In the illustration in FIG. 1 is only illustrated one length where the width 2 of the sheet is relatively narrow such that on an actual reel as illustrated with reference to FIG. 3 a number of lengths may be arranged laterally on the same reel. The material sheet 1 is in this embodiment provided with indication marks 3 which during production are used to identify the position of the sheet relative to a cut line 4 such that as the sheet 1 progresses through the packaging machine and the finished packages are shaped, each package will be separated from adjacent packages substantially along the cut line 4 as will be explained below with reference to FIG. 2.

For material sheets not provided with indication marks 3, the proper position of the cut-off lines 4 will be determined in another manner.

A slit 10 is provided across the cut-off line 4 in order to provide the easy-open effect which was described above. In this embodiment only 1 slit 10 has been provided, but as is evident from FIGS. 3 and 4 more substantially parallel slits 10′ may be provided in order to ensure that the slit is positioned correctly or most optimal relative to a longitudinal fin 50, see FIG. 6. The slit 10 is in this embodiment arranged substantially parallel to a side edge 5 of the sheet material, but may be arranged at any angle relative to the side edge 5 within the range of 0-60° relative to the side edge 5. The extent of the slit 10 should be such that in the finished package the slit will be present in the sealing zones delimiting the ends of the finished package 100 as illustrated with reference to FIG. 6.

In the described example the slit 10 is present partly in the cross seal. It is however not necessary that the slit enters the sealed zone. As long as a slit is provided adjacent a side, the effect of the invention will be achieved. It should however be noted that improved opening characteristics, especially where very strong seals are used, may be obtained when the slit extends into the seal.

Turning to FIG. 2 the position of the slit 10 relative to the cut-off line 4 will be discussed. In this context it should be noted that the dashed lines illustrated in FIG. 2 are only for descriptive purposes and will naturally not be present on an actual material sheet 1 according to the present invention, but only indicated in order to provide understanding for the positioning of the slit 10 relative to the cut-off line 4.

The slit 10 should be placed across the cut-off line 4 such that a portion of a slit is provided on the material sheets 1′ and 1″ such that as the two resulting packages are separated along the cut-off line 4, part of the slit 10 will be present in both neighbouring packages 1′ and 1″.

In order to take into account the very high speed with which the packaging machines operate certain tolerances are allowed for the positioning of the cut-off line 4 which are indicated by the tolerance zone 6. It is therefore contemplated that the cut-off line may be present in any of the tolerance zones 6 such that for example the resulting package from sheet material section 1′ may be slightly longer than the corresponding packaging size for the section 1″. Adjacent the tolerance zones which in practice will be selected to plus/minus 1-3 mm, a sealing zone 7 is provided. In this zone the sealing of the resulting packages is foreseen to be placed. Typically, this may be a weld where the material sheet is passed through a welding mechanism fusing the material layers together in order to create a closed end in the resulting package. The sealing zone 7 will typically be selected to have an extent of 7-15 mm depending of the type of sheet material and the type of sealing machine which is used.

With these measurements in mind, i.e. the width of the tolerance zone 6, and the sealing zone 7 the extent of the slit 10 should be selected to around 7 mm or up to 10 mm whereby it is ensured that the slit will be present in both sealing zones 7 on both adjacent packages 1′, 1″. This is obviously not necessary, in embodiments where the slit is not to enter the sealing zone.

In FIG. 3 is illustrated a packaging material sheet 20 comprising 5 lengths 1 of sheet material according to the invention. The lengths are connected side by side such that when the sheet material 20 is wound onto a reel, 5 lengths of packaging material will be arranged laterally on said reel. In order to illustrate the material necessary for a single package, a single packaging sheet 1′ has been “cut out of the length of sheet material 1. As illustrated half slits 10” are present along the cut-off lines 4 whereby it is evident that the slit in this embodiment crosses the cut-off line 4 such that slits are simultaneously provided in two adjacent material sheets.

In FIG. 4 is furthermore illustrated an embodiment where slits are provided crossing every other cut-off line 4 such that slits 10′ will only be provided along one cut-off line for each single material sheet 11, 12.

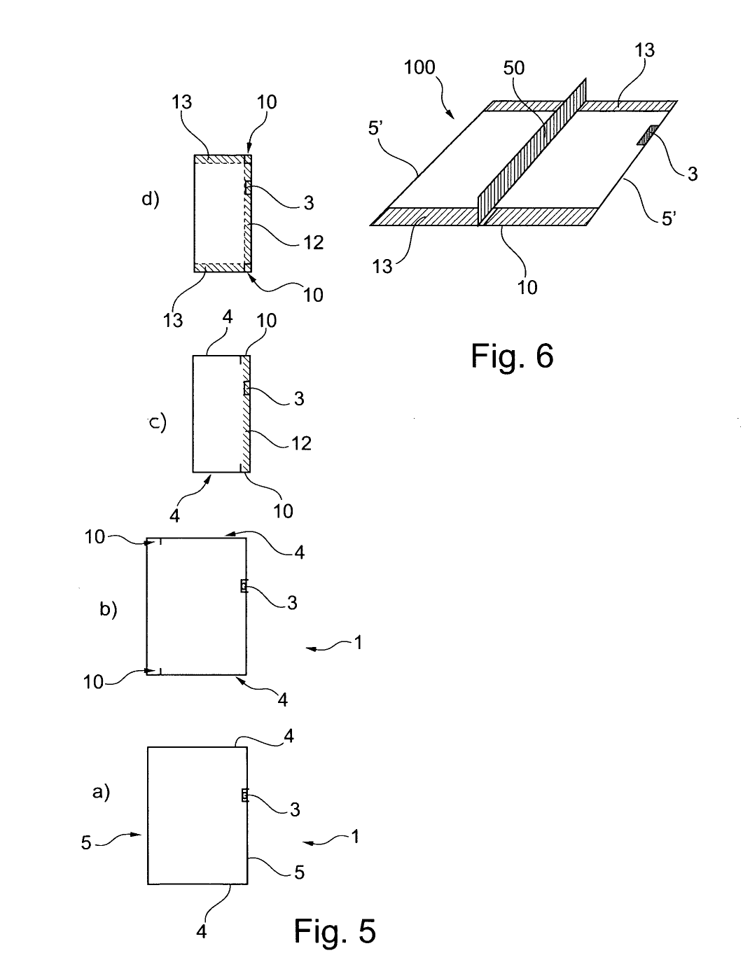

One advantage of this embodiment is the fact that the material sheet 1 is less weakened by only providing slits 10′ across every other cut-off line 4 in each length such that the weakness provided in the sheet due to the provision of the slits 10′ is spread across the material sheet 1 and is less as only half as many slits are provided. Also for manufacturing purposes the manufacturing speed may be increased in that the device creating the slits only has to be applied half as often as for example is the case with reference to the embodiment described above with reference to FIG. 3. With reference to FIGS. 5a, b, c and d the figure illustrates the progress from being a material sheet towards being a finished package. In FIG. 5a a single sheet according to the prior art is provided. The indication mark 3 as well as cut off lines 4 and sides 5 of the sheet are recognizable. In connection with the present invention it is of very little importance how the single sheets are made up, i.e. how many layers whether there is only a single layer or a multi-layer construction as already discussed above. The invention will function well with any type of layer construction.

Between FIGS. 5a and 5b the sheet 1 has been provided with part of a slit 10 along either cut-off line 4 being the limits of the package in the longitudinal direction.

Between FIGS. 5b and 5c the sheet has been folded on itself about a longitudinal axis such that the two edges 5 are superposed and connected as indicated by the seal 12. In this configuration the sheet as illustrated with reference to FIG. 5c is in the shape of a tube with open ends along the cut-off lines 4.

Between FIGS. 5c and 5d the tube provided in 5c has been filled with the objects to be packaged (not illustrated) and a cross seal 13 has been provided in either end of the package thereby effectively delimiting the volume inside the package from influences from outside.

In FIG. 6 is illustrated a perspective view of a package according to the invention which has been manufactured for example by progressing through the illustrated steps with reference to FIG. 5a-d. When the two side edges 5, see FIG. 5a, are superposed and sealed together as illustrated with reference to FIG. 5c and the seal 12, the fin 50 is created. Depending on the position of the slit 10 relative to the indication mark 3, in some embodiments the indication mark 3 may be positioned as illustrated in FIG. 6, but the fin may also be positioned adjacent one of the edges 5′ of the finished package 100.

Although the invention has been explained with reference to detailed embodiments with reference to the drawings the scope of protection shall only be limited by the appended claims.

1. Sheet packaging material, of the type used for packaging objects on automatic packaging machines where the material is supplied in very long lengths on reels, where said material may be a single or multi layer material, where means are provided for determining where cut-off lines shall be placed, where cut-off lines are lines substantially perpendicular to the longitudinal direction of the packaging material, which lines indicate sections where the material will be cut when separating the packages from each other after the material has been formed into a package, and where one or more substantially parallel longitudinal slit(s) parallel with the side of the packaging material are provided extending at least a certain distance from each of every or every other of said cut-off lines.

2. Sheet packaging material according to claim 1 where the material is provided with indication marks, where said marks are spaced along the material corresponding to the finished package size, and where the at least one slit is arranged relative to the indication marks.

3. Sheet packaging material according to claim 1 where the one or more substantially parallel longitudinal slit(s) parallel with the side of the packaging material extends across and on both sides of the cut-off lines.

4. Sheet packaging material according to claim 1 where in the longitudinal direction of the material, on either side of the cut-off lines a tolerance area of +/−1-3 mm in the longitudinal direction is provided, adjacent which on both sides of the tolerance area a sealing zone of 7 to 15 mm is provided, and where the slits are present in the sealing zone.

5. Sheet packaging material according to claim 1, where the slits are arranged adjacent one longitudinal side of the material, where the outermost slit is spaced 5 to 25 mm from said side.

6. Sheet packaging material according to claim 1, where the material comprises a plurality of layers, where each layer has different characteristics, and where the slit at least penetrates one layer.

7. Sheet packaging material, according to claim 1 where pluralities of material lengths are laterally arranged on the same reel.

8. Method for manufacturing a sheet packaging material according to claim 1, suitable to be used in an automatic packaging machine, where means are provided for determining the position of cut-off lines transverse to the longitudinal direction of the material, which cut-off lines determines the longitudinal length of each package to be, where the material is unwound and passed by a cutting means, where said cutting means cuts one or more slits in a position relative to the cut-off lines and at a predetermined distance from the side edge of the material, such that the one or more slits extends from said cut-off lines.

9. Method for manufacturing a sheet packaging material according to claim 1, suitable to be used in an automatic packaging machine, where means are provided for determining the position of cut-off lines transverse to the longitudinal direction of the material, which cut-off lines determines the longitudinal length of each package to be, where the material is unwound and passed by a cutting means, where said cutting means cuts one or more slits in a position relative to the cut-off lines and at a predetermined distance from the side edge of the material, such that the one or more slits extends from said cut-off lines.

10. Method for manufacturing a sheet packaging material according to claim 8 wherein the one or more slits traverses every or every other cut-off line between adjacent packages to be, before the material is being wound up on a reel again.

11. Method according to claim 8 where a material length is the material necessary for one package which is limited sideways by sidelines, and lengthwise by the cut-off lines, where a plurality of material lengths are arranged laterally on the same material sheet.

12. Method according to claim 8 wherein a plurality of slits are positioned adjacent the sidelines on the material sheet, where the slits traverses either every, or every other cut-off line.
